(19) United States
(12) Patent Application Publication
(10) Pub. No.: US 2017/0169700 A9
(43) Pub. Date: Jun. 15, 2017

(54) SYSTEM AND METHOD FOR EMERGENCY MESSAGE PREVIEW AND TRANSMISSION

(71) Applicants: Daniel G. Farley, Westminster, MA (US); Matthew Farley, Gardner, MA (US); John R. Haynes, Groton, MA (US)

(72) Inventors: Daniel G. Farley, Westminster, MA (US); Matthew Farley, Gardner, MA (US); John R. Haynes, Groton, MA (US)

(73) Assignee: SIMPLEXGRINNELL LP, Westminster, MA (US)

(21) Appl. No.: 13/207,140

(22) Filed: Aug. 10, 2011

Related U.S. Application Data
(63) Continuation of application No. 11/514,612, filed on Sep. 1, 2006, now Pat. No. 8,319,625.
(60) Provisional application No. 60/713,569, filed on Sep. 1, 2005.

(51) Int. Cl. G10L 15/26; G10L 21/06

(52) U.S. Cl. CPC G08B 25/14

(57) ABSTRACT

In accordance with the embodiments of the present invention, a system and method for enabling preview, editing, and transmission of emergency notification messages is provided. The system includes a controller, a microphone, and a speech-to-text engine for receiving an audio message input to the microphone and for convert the audio message to a text message. The resulting text message is displayed on a local display, where a user can edit the message via a text editor. Text and/or audio notification devices are provided for displaying the edited text data as a text message. Other embodiments are disclosed and claimed.

### FIELD OF THE DISCLOSURE

This invention relates generally to emergency notification systems, and more particularly to a system and method for providing speech-to-text translation, preview, and transmission of emergency notification messages.

### BACKGROUND OF THE DISCLOSURE

Typical building fire alarm systems include a number of fire detectors positioned throughout a building. Signals from those detectors are monitored by a system controller, which, upon sensing an alarm condition, sounds one or more audible alarms throughout the building. Flashing light strobes may also be positioned throughout the building to provide a visual alarm indication

While in many situations such audible alarms and strobes operate sufficiently to notify an alarm condition, in other situations these alarms are insufficient. For example, the audible alarm can be difficult to hear in areas with high noise or poor acoustic properties. In addition, audible alarms cannot be used in areas requiring quiet, such as for example explosives areas. Still further, audible alarms are of limited usefulness in areas with populations that include the deaf and hard of hearing.

In addition to audible alarms, spoken live voice messages can be passed from an operator directly through a building's speaker system. Such spoken live messages, however, are susceptible to a variety of problems, including operator misspeaking, inadvertent provision of incorrect instructions, and unintelligibility of instructions.

Current approaches to improving intelligibility of audible instructions in the fire alarm industry have focused on improving quality of equipment, quality of speakers, layout of speakers, and loudness of the speakers. Little focus has been placed on improving the intelligibility of the message itself.

### SUMMARY

Although voice message preview functionality exists in systems such as voicemail, such functionality has not been implemented in fire alarm systems. In addition, such voice message preview capabilities have not been combined with speech-to-text systems in any application.

It would, therefore, be desirable to provide a system and method for enabling generation of emergency instruction text messages using a speech-to-text functionality. It would also be desirable to provide a system and method for and verifying the accuracy of such text messages before they are transmitted to text displays viewable by building occupants.

An emergency notification system is disclosed. The emergency system can include a system controller, a microphone coupled to the system controller, and a speech-to-text engine coupled to the microphone and the system controller. The speech-to-text engine can be configured to receive audio data from the microphone and to convert the received audio data to text data. In one embodiment, the system can also include a local display for displaying the converted text data, and a text editor for editing the displayed text data. A text notification device is also included for displaying the text data as a text message. The text notification device can be coupled to the system controller, and can be disposed at a location remote from the system controller.

A method of providing a notification is disclosed. The method includes: receiving audio data, converting the received audio data to text data, displaying the converted text data to a user as a text message, editing the text message, and transmitting the edited text message for display on a remote text notification device. The edited text message can be an emergency notification provided to at least one occupant of a building in which an alarm condition has been identified.

A notification system is disclosed, including a workstation having a processor, a memory, a microphone, a display and a keyboard. The workstation is configured to receive an audible message via the microphone and to convert the audible message to a text message. The workstation can display the text message on the display to enable a user to edit the displayed text message using the keyboard. The system also includes a text notification device coupled to the workstation, the text notification device configured to display the edited text message.

The disclosed system and method provide improved emergency communications capabilities which reduce the chance that incorrect or unintelligible communications will be given during an emergency. In one embodiment, a user can speak into a microphone to record an audible message. The audible message is automatically converted to a text message, and the converted text message is displayed to the user. The user can review and edit the text message prior to sending it to building occupants. The display can be a computer monitor or other display device.

By automatically converting a voice message to a text message and displaying the text message locally, the user can validate the correctness of the message prior to sending the message to building occupants.

In some embodiments, the user interface includes functionality that highlights any word that the speech-to-text engine is unable to interpret, or indicates a low probability of correctness of the interpretation that is made. This can facilitate identification of unintelligible portions of the audio message, and can also allow the user to quickly correct a word that was not in the speech-to-text engine's dictionary.

As will be appreciated, the disclosed system and method can be implemented as part of an existing workstation, or it can be an add-on feature implemented in new workstations.

### BRIEF DESCRIPTION OF THE DRAWINGS

By way of example, a specific embodiment of the disclosed device will now be described, with reference to the accompanying drawings, in which:

FIG. 1 is a schematic of an alarm system formed in accordance with an embodiment of the present invention;

FIG. 2 is a block diagram of an exemplary fire panel for use in the alarm system of FIG. 1;

FIG. 3 shows an example signboard of the alarm system of FIG. 1;

FIG. 4 is a schematic of an exemplary workstation for use in the alarm system of FIG. 1;

FIG. 5 is an exemplary screenshot of a user interface illustrating the disclosed message preview capability; and

FIG. 6 is a process flow diagram illustrating a method of using the disclosed.

### DETAILED DESCRIPTION

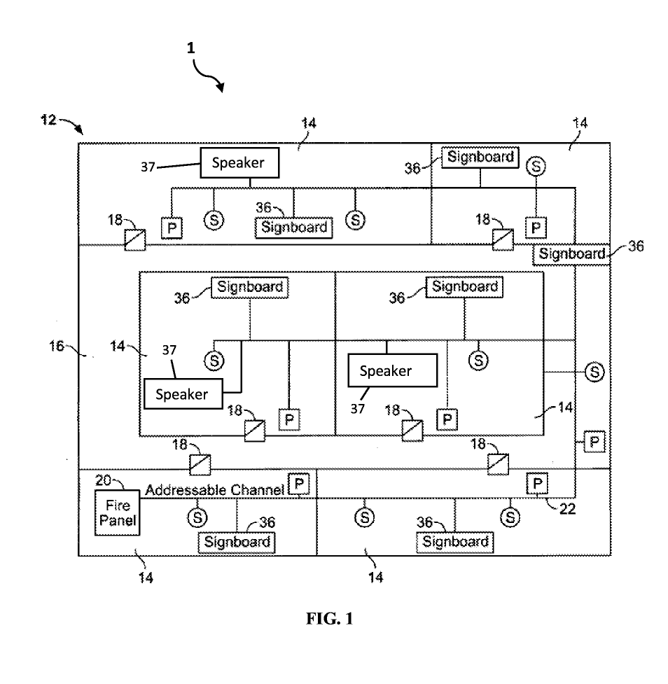

FIG. 1 is a schematic of an exemplary alarm system 1, which is shown as a floor 12 of a single or a multi-story building. The floor 12 includes a plurality of rooms 14, and a hallway 16 that allows ingress and egress to and from the rooms 14. Each room 14 is shown connected to the hallway 16 by a door 18.

The alarm system includes a fire panel 20 coupled to a detector network 22. The detector network 22 can include an addressable channel that connects to a plurality of initiation devices such as smoke detectors (S), pull stations (P), toxic or flammable gas detectors, heat detectors, or any of a variety of other types of hazard detectors, which may be distributed throughout the rooms 14 and hallway 16. In one embodiment, standard notification devices such as audible alarms and light strobe alarms can be provided connected in the detector network 22. When an alarm condition is sensed, the system controller 27 commands an alarm signal to be sent from the fire panel 20 to the appropriate devices through the detector network 22.

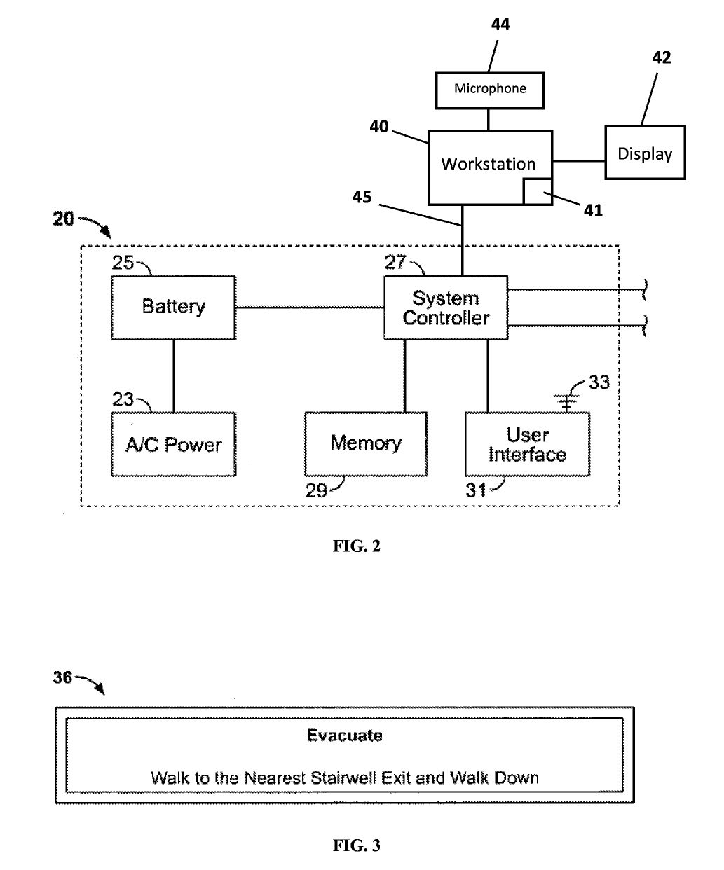

One or more textual notification devices 36, and one or more audible notification devices 37, can be provided in the detector network 22 integral to the alarm system 1. An example of a textual notification system is shown in U.S. Patent Application Publication No. 2007/0046455, titled “Fire Alarm Textual Notification Related Application,” the entirety of which is incorporated by reference herein. As with the initiation devices, each room 14 and the hallway 16 can include at least one textual notification device 36 and/or one audible notification device 37. Alarm messages can activated from the system controller 27 (FIG. 2) via the fire panel 20.

Although the illustrated embodiment shows the notification devices 36, 37 as being hardwired to the detector network 22, it will be appreciated that the devices 36, 37 may instead be wireless devices. For example, the audible notification device 37 can be a hard wired or wireless speaker. In addition, although he illustrated embodiment shows the audible notification device 37 as being hardwired to the detector network 22, it could instead be hardwired (or wireless) on a circuit that is separate from the detector network 22. The textual notification device 36 can be a hard-wired display using light emitting diode (LED) lights (or LCD, CRT, projection display, or the like) to display a commanded message. Alternatively, the textual notification device 36 can be the monitor of a desktop, laptop, or handheld computer, or it can be a pager, cell phone or any of a variety of other handheld device, including pagers.

In one non-limiting exemplary embodiment, the textual and audible notification devices 36, 37 are supervised via an addressable loop that is also connected to initiating and/or other notification devices installed in the network. One or more of the notification devices 36, 37 can be supervised, controlled, and powered directly from the fire panel 20. Alternatively, the notification devices 36, 37 may simply be receivers of messages transmitted by the fire panel 20, for example, where the textual notification devices 36 are cell phones, pagers, PDA's or desktop, laptop or handheld computers.

Referring to FIG. 2, a block diagram of the fire panel 20 is shown. The fire panel 20 can provide system power such as a power source 23 and battery back-up 25, as well as a system controller 27 that provides system control and supervision. Other standard elements such as memory 29, a user interface 31, and a wireless or wired communications interface 33 can be further provided.

The system controller 27 can be connected to, and controlled by, an external workstation 40 having a processor 41, a display 42 and a microphone 44. Such an arrangement facilitates centralized control of a multiplicity of fire panels 20 disposed on one or more buildings. In one embodiment, the external workstation 40 is a Simplex® TrueSite workstation that communicates with the system controller 27 via a communications link 45. The communication link 45 can be a PSTN (Public Switched Telephone Network), a cellular network such as, for example, a GSM (Global System for Mobile Communications) network for SMS and packet voice communication, General Packet Radio Service (GPRS) network for packet data and voice communication, or a wired data network such as, for example, Ethernet/Internet for TCP/IP, VOIP communication, etc. It will be appreciated that while the system controller 27 is described as being part of the fire panel 20, it could instead be part of the workstation 40, or it could be located separate from the fire panel 20 and the workstation 40.

In one embodiment, the textual notification device is hardwired or wireless LED signboard. FIG. 3 shows such a textual notification device in the form of a multi-line signboard 36. With a multi-line signboard 36, a first line may be constant for a given alarm condition and may provide a brief instructional message informing the building occupant of what action is necessary. Examples of such brief instructional message can include “Shelter in Place,” “Standby for Further Instructions” or, as provided in FIG. 3, “Evacuate.” The brief instructional message can be adapted to display different messages depending on the event coming into the alarm system.

Additional lines in a multi-line signboard 36 can scroll additional details about the alarm state. An example of such scrolled instructional message can include “Do not use the elevators! Walk to the nearest stairwell exit and walk down to street level and exit the building;” because this is a scrolling message, the additional line depicted in FIG. 3 shows only a portion of the scrolling message as follows (with that portion of the message either previously scrolled or yet to be displayed bracketed): “[Do not use the elevators. Walk to the nearest stairwell exit and walk down to street level and exit the building.]” The scrolled instructional message can be adapted to display different messages depending on the event coming into the alarm system.

The audible notification device 37 can be used to send an audible version of the message that is displayed on the textual notification device 36. Alternatively, the audible notification device 37 may be used to send messages that complement, or are otherwise different from, the text messages displayed on the textual notification device 36. The audible notification device 37 can be used to transmit audible messages input by a user using microphone 44 at the workstation 40.

Instructional messages, whether they are to be displayed on the textual notification device 36 or broadcast using the audible notification device, are input to the system 1 by a user. In one embodiment, audible messages are input to the system 1 by a user speaking into a microphone 44 associated with the workstation.

In one embodiment, the system 1 includes the capability for automatically translating audible messages that are input via the microphone 44 into text that is viewable on the display 42 prior to transmission to the fire panel 20.

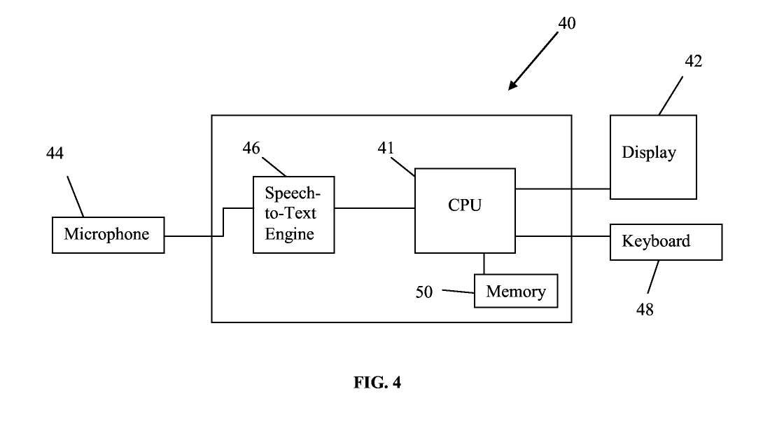

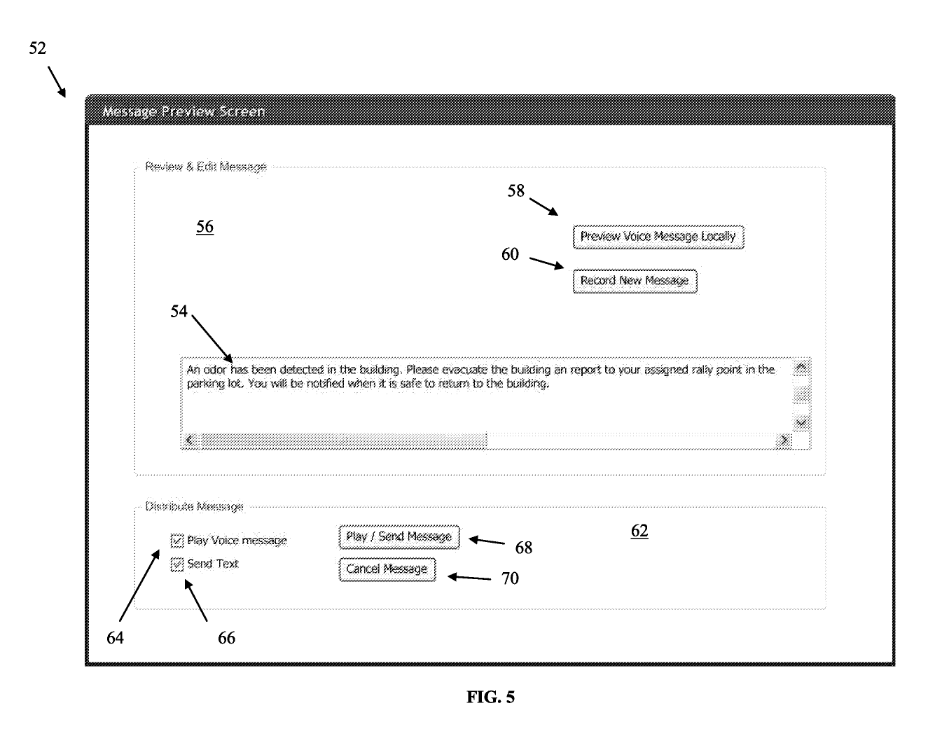

FIG. 4 illustrates the integration of a speech-to-text engine 46 in workstation 40. In this embodiment, the workstation also includes a keyboard 48, and memory 50 associated with processor 41. The speech-to-text engine 46 is shown taking input from the microphone 44 and providing output to the processor 41. It will be appreciated, however, that this arrangement is merely representational, and the actual connection scheme between components may be different. For example, in one exemplary embodiment the speech-to-text engine 46 is a software program running on the processor 41.

Logically, audio data input via the microphone 44 is input to the speech-to-text engine 46, which converts the audio data into text data, which is stored in memory 50 as a file having an appropriate format, such as .wav, .wma, .mp3, or any other appropriate format for storing and processing digitized audio. The text data is also displayed as viewable text on the display 42. The user can preview the viewable text (i.e., the text message) to verify its accuracy prior to sending the message to building occupants via the textual notification device 36.

Because the audio data is stored as a data file (i.e., .wav, .wma, .mp3), additional processing can be performed on the data. For example, additional processing can be aimed at making the message more intelligible. In one embodiment, such additional processing can include compression to decrease extremely loud portions of a message that can result in overdriving the speakers 37 and make the message unintelligible. Alternatively, or in combination, such additional processing can include increasing the volume of messages that are spoken too softly, or equalization to increase base or other frequencies to better reproduce voice on the speakers 37.

In addition, the converted text can be automatically translated into one or more alternative languages such as French or Spanish, and sent to the textual notification devices 36 in those languages. Furthermore, the converted text (either before or after editing) can be converted back to audio data which can then be transmitted to one or more audible notification devices 37 for issuance.

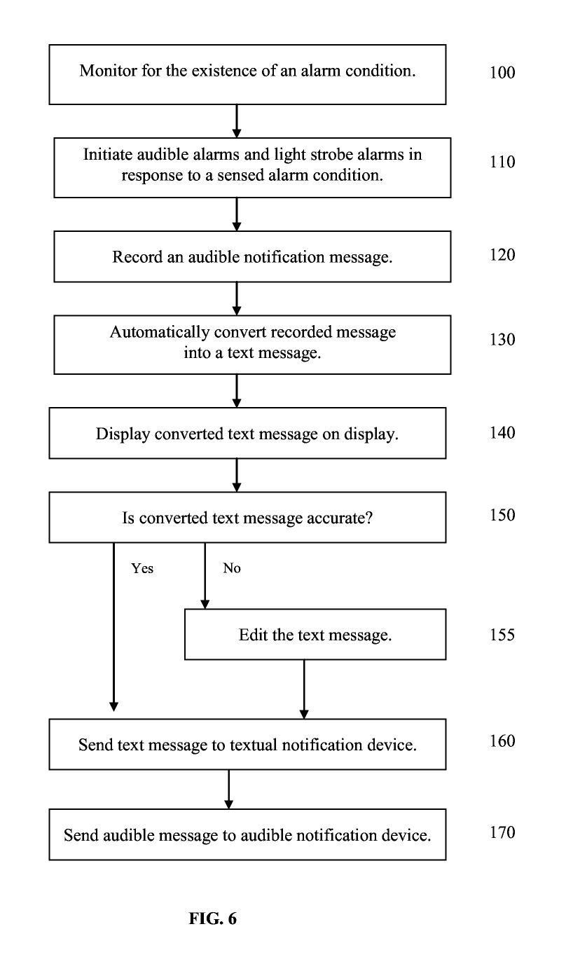

FIG. 5 shows a screenshot of an exemplary user interface screen 52 that can be displayed on the display 42 of the workstation 40. The user may initiate the process by activating button 60 “Record New Message” and then speaking into microphone 44. The spoken (audio) message is automatically converted to text and the text message 54 is displayed in a “Review & Edit Message” portion 56 of the screen 52. Softkeys 58, 60 are provided to enable the user to preview the voice (i.e., audible) message locally at the workstation 40, and/or to record a new message. A “Distribute Message” portion 62 of the screen 52 includes check boxes 64, 66 to enable the user to play the recorded voice message and to send the text message to one or more of the textual notification devices 36. In some embodiments, the text message may be sent only to a selected group of textual notification devices 36. Softkeys 68, 70 enable the user to play/send the message to building occupants and to cancel the message.

To edit a converted message (e.g., message 54), the user may move a cursor to the appropriate location in the message 54 and edit the text (add, delete, modify) in a manner associated with normal word processing. In this manner, the user can identify and correct any mistakes in the text translation prior to sending the text message to occupants via the textual notification device 36.

In some embodiments, it may be possible for the user to simply enter the text message by typing it on the keyboard 48. The typed message may then be converted to audio in the manner previously described, and the audio and text messages can be sent to the appropriate textual and audible notification devices 36, 37. Typically, this may take longer than embodiments in which a spoken message is automatically converted to text, but it may be efficient for very short messages.

The speech-to-text engine 46 can be any of a variety of known speech-to-text systems, including those marketed under the Dragon® Speech Recognition Software name, as well as systems offered by Microsoft®. In one embodiment, a Microsoft® Speech SDK 5.1 software development kit can be used to implement the speech-to-text engine 46 in workstation 40.

The speech-to-text engine 46 may be configured to identify portions of translated text that it either does not recognize, or that it recognizes but determines has less than a predetermined percentage likelihood of accuracy. In one embodiment, the Application Programming Interface (API) for the speech-to-text engine 46 may return a probability of correctness for each word that it interprets. In general, the speech-to-text engine 46 performs the recognition/identification function by comparing properties of an input audio clip to properties of particular words contained in an internal dictionary. Multiple words in the dictionary may have similarities to the individual words of the input audio, but fewer words (ideally one word) will be most similar to each input word, and thus will have a higher “score” than other candidate words. The highest scoring word is then presented on the display as corresponding text. Where more than one word is identified as corresponding to a word in the input audio (i.e., where several words have a similar score), the speech-to-text engine 46 may select the highest ranking candidate word, but may identify that candidate word to a user as requiring confirmation. This identification may be shown as highlighting of the suspect text. In one example, the speech-to-text engine 46 may be set to highlight specific text that it determines to have a less than 80% chance of being accurate. This predetermined percentage can be user selectable. In one embodiment, the speech-to-text engine 46 identifies for highlighting words that are not found in its internal dictionary. The speech-to-text engine 46 may also identify for highlighting sections of text that appear to be grammatically incorrect.

Although the workstation 40 is illustrated in FIG. 2 as being separate from the fire panel 20, it will be appreciated that some or all of the functionality of the workstation 40 can be incorporated into the fire panel 20. The system 1 can be integrated into the fire panel 20 as a bay including a microphone, a display, and a computer. The computer may include a processor that is separate from, or the same as, the system controller 27. Thus, a user at the fire panel 20 may speak a message into a microphone at the fire panel. The message may be converted to text and displayed on a display at the fire panel. The user can verify the accuracy of the message, as well as the accuracy of the text translation, prior to sending the message to building occupants or others.

Referring to FIG. 6, a method for using the disclosed system 1 will be described in relation to an exemplary emergency alarm response. It will be appreciated, however, that the system 1 can also be used for non-alarm conditions as well (e.g., early school closing announcements and the like). Initially, at step 100 the system may monitor for the existence of an alarm condition. If an alarm condition is initiated from an initiating device such as a smoke detector (S) or a pull station (P), then at step 110 standard alarms such as audible alarms and light strobe alarms are triggered. At step 120, a user speaks into microphone 44 and records an audible message intended to be sent to building occupants regarding the alarm. It will be appreciated that there can be circumstances under which a user may initiate and audible/textual notification without an alarm being triggered (e.g., an impending hurricane, tornado or flood, or a trespasser is detected). In such instances, step 110 may not be required to initiate an audible/textual alarm notification. In either case, at step 130, the recorded audible message is automatically converted to a text message. At step 140, the text message is displayed locally to the user via the workstation display 42. At step 150, the user reviews the text message for accuracy. Optionally, the user may also review the audible message. If the text message is determined to be accurate, then upon user acceptance at step 160 the text message is sent to the textual notification devices 36. Optionally, prior to sending the text message in step 160, the message may be converted to another language and sent to one or more of the textual notification devices 36 in that other language. Optionally, at step 170, the audible message is sent to the audible notification devices 37. If, at step 150, the text message is determined to be inaccurate, then at step 155 the text message is edited at the workstation 40 using the keyboard 48. The edited text message is then sent to the textual notification devices 36 at step 160. Audible and textual messages may be sent out separately, or they may be sent simultaneously.

It will be appreciated that the user, upon previewing the translated message, or upon reviewing the audible version of the message, may decide to re-record the message for any reason. The disclosed system 1 enables the user to preview the audible message to confirm its content and clarity. The system 1 also enables the user to preview and edit the text message to confirm its content. After the audible and text messages have been confirmed by the user, they can be sent to building occupants via the textual and audible notification devices 36, 37.

As previously noted, these messages may be transmitted via hard wired or wireless connections, via a public or private communications network, to any of a variety of textual notification devices 36, a non-limiting list of which include sign boards, cell phones, desktop, laptop or handheld computers, and pagers. In addition, the audible and text messages may be played and displayed locally and/or may be played and displayed at the fire panel 20 or other location. For example, the audible and text messages may be played remotely at a local fire and/or police department facility.

Some embodiments of the disclosed device may be implemented, for example, using a storage medium, a computer-readable medium or an article of manufacture which may store an instruction or a set of instructions that, if executed by a machine, may cause the machine to perform a method and/or operations in accordance with embodiments of the disclosure. Such a machine may include, for example, any suitable processing platform, computing platform, computing device, processing device, computing system, processing system, computer, processor, or the like, and may be implemented using any suitable combination of hardware and/or software. The computer-readable medium or article may include, for example, any suitable type of memory unit, memory device, memory article, memory medium, storage device, storage article, storage medium and/or storage unit, for example, memory (including non-transitory memory), removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions may include any suitable type of code, such as source code, compiled code, interpreted code, executable code, static code, dynamic code, encrypted code, and the like, implemented using any suitable high-level, low-level, object-oriented, visual, compiled and/or interpreted programming language.

As used herein, an element or step recited in the singular and proceeded with the word “a” or “an” should be understood as not excluding plural elements or steps, unless such exclusion is explicitly recited. Furthermore, references to “one embodiment” of the present invention are not intended to be interpreted as excluding the existence of additional embodiments that also incorporate the recited features. The term computer is not limited to just those integrated circuits referred to in the art as computers, but broadly refers to, microprocessors, microcontrollers, microcomputers, programmable logic controllers, application specific integrated circuits, and other programmable circuits, and these terms are used interchangeably herein.

While certain embodiments of the disclosure have been described herein, it is not intended that the disclosure be limited thereto, as it is intended that the disclosure be as broad in scope as the art will allow and that the specification be read likewise. Therefore, the above description should not be construed as limiting, but merely as exemplifications of particular embodiments. Those skilled in the art will envision other modifications within the scope and spirit of the claims appended hereto.

1. An emergency notification system comprising:
a system controller;
a microphone coupled to the system controller;
a speech-to-text engine coupled to the microphone and the system controller, the speech-to-text engine configured to receive audio data from the microphone and to convert the received audio data to text data; and
a text notification device for displaying the text data as a text message, the notification device coupled to the system controller, the text notification device disposed at a location remote from said system controller.

2. The emergency notification system of claim 1, further comprising an audio preview speaker coupled to the system controller, the audio preview speaker for providing an audible preview of the received audio data.

3. The emergency notification system of claim 2, further comprising a non-volatile storage medium coupled to the system controller for storing the received audio data.

4. The emergency notification system of claim 1, further comprising an audible notification device for issuing an audible message representative of the received audio data.

5. The emergency notification system of claim 4, wherein the audible message includes content identical to content of the text message displayed on the text notification device.

6. The emergency notification system of claim 4, wherein the text notification device and the audible notification device are a single notification device.

7. The emergency notification system of claim 6, wherein the single notification device is a personal computer, a cellular telephone or a personal digital assistant.

8. The emergency notification system of claim 1, further comprising a local display for displaying the converted text data.

9. The emergency notification system of claim 8, further comprising a text editor for editing the displayed text.

10. A method of providing a notification, comprising:
receiving audio data;
converting the received audio data to text data;
displaying the converted text data to a user as a text message;
editing the text message; and
transmitting the edited text message for display on a remote text notification device;
wherein the edited text message is an emergency notification provided to at least one occupant of a building in which an alarm condition has been identified.

11. The method of claim 10, further comprising providing an audible preview of the received audio data.

12. The method of claim 11, further comprising storing the received audio data in a non-volatile storage medium.

13. The method of claim 10, further comprising issuing an audible message representative of the received audio data.

14. The method of claim 13, wherein the audible message includes content identical to content of the text message displayed on the text notification device.

15. The method of claim 14, wherein the text notification device and the audible notification device are a single notification device.

16. The method of claim 15, wherein the single notification device is a personal computer, a cellular telephone or a personal digital assistant.

17. The method of claim 10, wherein the received audio data is representative of a message received in a first language, the method further comprising translating the edited text message into a second language that is different from the first language, and transmitting the translated text message for display on the remote text notification device.

18. The method of claim 10, further comprising converting the edited text message to converted audio data and transmitting the converted audio data for issuance on a remote audible notification device.

19. A notification system, comprising a workstation having a processor, a memory, a microphone, a display and a keyboard:
the workstation configured to receive an audible message via the microphone and to convert the audible message to a text message, the workstation further configured to display the text message on the display to enable a user to edit the displayed text message using the keyboard; and
a text notification device coupled to the workstation, the text notification device configured to display the edited text message.

20. The notification system of claim 19, further comprising a fire panel in communication with the workstation, the fire panel coupled to the remote text notification device.

21. The notification system of claim 19, further comprising an audible notification device coupled to the workstation, the audible notification device for issuing an audible alert containing content that is identical to content of the text message.

22. The notification system of claim 21, wherein the audible notification device and the text notification device are included in a single remote device.

23. The notification system of claim 22, wherein the single remote device is a personal computer, a cellular telephone or a personal digital assistant.

24. The notification system of claim 19, wherein the text notification device is located remote from the workstation, and is coupled to the workstation via a wireless connection or a public or private network.
